(19) United States
(12) Patent Application Publication
(10) Pub. No.: US 2011/0042535 A1
(43) Pub. Date: Feb. 24, 2011

(54) POSITIONING APPARATUS FOR OPTICAL INSTRUMENT

(76) Inventor: Ming-Chung CHENG, Taichung City (TW)

Correspondence Address: Muncy, Geissler, Olds & Lowe, PLLC, 4000 Legato Road, Suite 310, FAIRFAX, VA, 22033, US

(21) Appl. No.: 12/856,071

(22) Filed: Aug. 13, 2010

(30) Foreign Application Priority Data
Aug. 18, 2009 (TW) 098127723

(51) Int. Cl. F16M 13/00

(52) U.S. Cl. 248/298.1

(57) ABSTRACT

A positioning apparatus for an optical instrument of the present invention includes a base seat, a holder and at least one sliding member. The bottom of the base seat is formed with a sliding groove. The sliding groove has an opening facing downward. The width of the opening is smaller than the maximum width of the sliding groove. The base seat is formed with plurality of fixation holes, which are arranged along the longitudinal direction of the sliding groove. The holder is disposed on the base seat. The holder is adapted for the optical instrument to be assembled thereon. The sliding member has a suitable cross-section, so that the sliding member is slidably disposed in the sliding groove. The sliding member abuts selectively against one of the fixation holes. As such, the sliding member is adjustable and can be held in the sliding groove.

### BACKGROUND OF THE INVENTION

1. Field of the Invention

The present invention relates to a positioning apparatus, especially relates to a positioning apparatus which is adapted for an optical instrument to be assembled thereon.

2. Description of the Prior Art

Optical instruments, such as single-lens reflex camera, video camera or astronomical telescope, are highly concentrated on their optical properties. To show the fine technique of the instruments, a reliable apparatus for firmly putting up the instrument is necessary.

Positioning apparatus which is assembled with a tripod and a holder is used to put optical instruments up. To make the position of the holder with respect to the tripod being adjustable, the positioning apparatus is further assembled with a positioner, as shown in FIG. 1. The positioner is slidable with respect to the tripod. The positioner has a sliding groove 101. The positioner is formed with two threaded holes 102. The threaded holes 102 are located on a side wall of the sliding groove 101. The threaded holes 102 are adapted for screws 103 to screw therein. When a sliding piece is slidably disposed in the sliding groove, the screw 103 can abut against the sliding piece when users tweak the distal end of the screw. However, the optical instrument usually has a considerable weight. When user tweaks the screw, the sliding piece may suddenly fall out with the optical instrument by the heavy weight. As a result, the user may meet a terrible bill about reparation.

The present invention is, therefore, arisen to obviate or at least mitigate the above mentioned disadvantages.

### SUMMARY OF THE INVENTION

The main object of the present invention is to provide a positioning apparatus which can be moved in multi-stage and can be fixed with respect to a tripod.

To achieve the above and other objects, a positioning apparatus for an optical instrument of the present invention includes

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a positioner of a prior art;

FIG. 2 is a stereogram showing a first embodiment of the present invention which is put upside down;

FIG. 2A is a stereogram showing another embodiment of the sliding member of the present invention;

FIG. 3 is a breakdown drawing showing a first embodiment of the present invention which is put upside down;

FIG. 4 is a stereogram showing a first embodiment of the present invention;

FIG. 5 is an AA profile of FIG. 4;

FIG. 6 is a BB profile of FIG. 4;

FIG. 6A is a profile showing a second embodiment of the present invention;

FIG. 6B is a profile showing a third embodiment of the present invention;

FIG. 7 is a side view showing the combination of an optical instrument, a tripod and the positioning apparatus of the present invention;

FIG. 8 is a side view showing the combination of an optical instrument, a tripod and the positioning apparatus of the present invention;

FIG. 8A is a stereogram showing a fourth embodiment of the present invention.

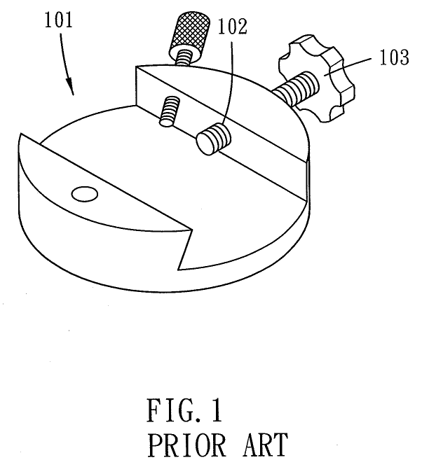

### DETAILED DESCRIPTION OF THE PREFERRED EMBODIMENTS

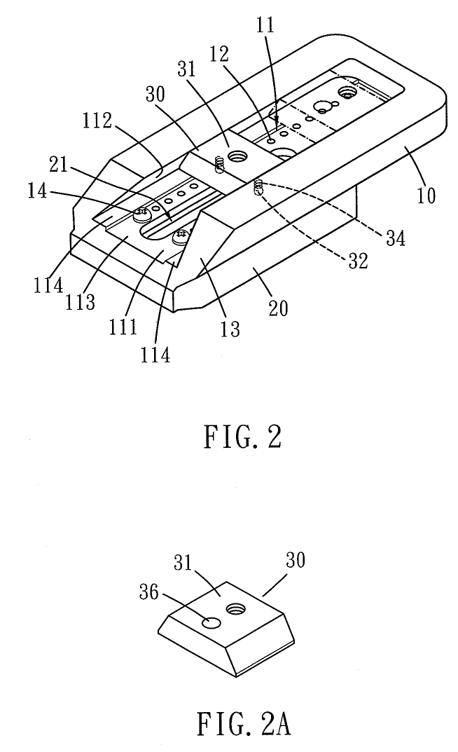

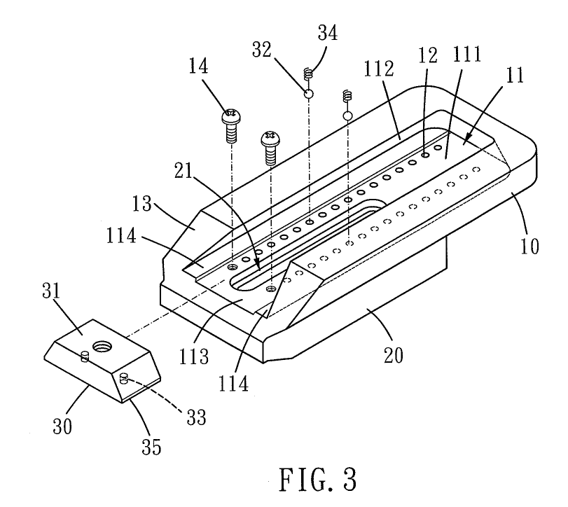

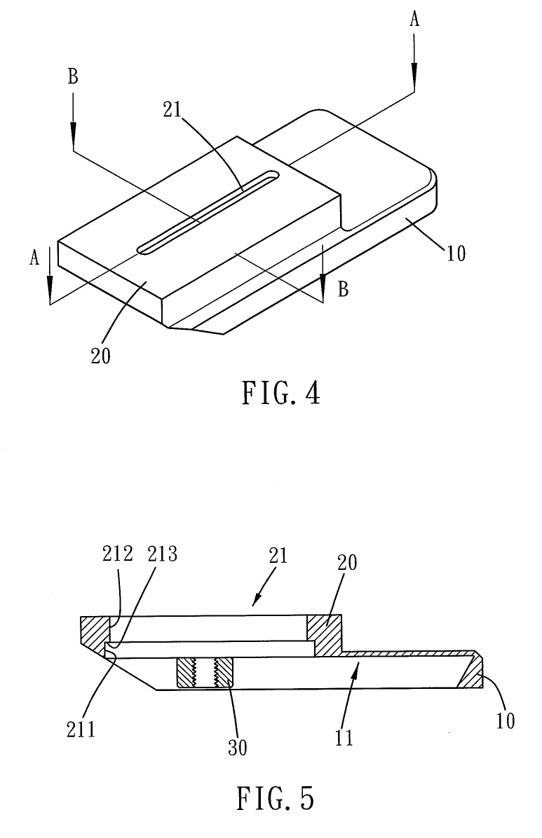

Please refer to FIG. 2 to FIG. 6 for a first embodiment of the present invention. The positioning apparatus for an optical instrument of the present embodiment includes a base seat 10, a holder 20 and at least one sliding piece 30.

The base seat 10 has a bottom. The base seat 10 is formed with a sliding groove 11 at the bottom. The base seat 10 has as least one wall surface. The sliding groove 11 is defined by the wall surface. The sliding groove 11 has an opening facing downward. A width of the opening is smaller than a maximum width of the sliding groove 11. At least one wall surface is formed with plurality of fixation holes 12. The fixation holes 12 are arranged along a longitudinal direction of the wall surface. In first embodiment of the present invention, the sliding groove 11 has a dovetail-shaped cross-section. As such, the base seat has three wall surfaces, including one bottom surface 111 and two side surfaces 112. The bottom surface 111 is located between the side surfaces 112. The bottom surface 111 may be further separated in an intermediate section 113 and two side sections 114 along a width direction of the bottom surface 111. The intermediate section 113 connects between the side sections 114. A depth from the opening to the intermediate section 113 is greater than a depth from the opening to each one of the side sections 114, so that the contact area between the bottom surface 111 and the sliding member 30 is cut down. As such, the sliding member 30 can slide with respect to the base seat 10 easily. The fixation holes 12 are located on the bottom surface 111. The fixation holes 12 are equidistantly arranged in two rows. In other possible embodiments of the present invention, the fixation holes 12 may be located on the side surfaces 112. The sliding groove 11 has an open end in its longitudinal direction. The open end is adapted for the sliding member 30 to be disposed in the sliding groove 11. Preferably, the base seat 10 is formed with a slant surface 13. The open end is located on the slant surface 13. The bottom surface 111 is more protruding than the opening at the open end, so that the sliding member 30 which has a trapezoidal cross-section can be disposed in the sliding groove 11 more easily. Probably, the slant surface 13 may tilt to the other side, so that the opening is more protruding than the bottom surface 111 at the open end. Preferably, the angle between the slant surface 13 and the bottom surface 111 is between 30 and 75 degrees. An extremely large angle may make an unobvious effect, and an extremely small angle may make the slant surface 13 too long.

The holder 20 is disposed on the base seat 10. The holder 20 is adapted for the optical instrument to be disposed thereon. In first embodiment of the present invention, the holder 20 is disposed upon the base seat 10. The holder 20 is formed with an extension groove 21 for the optical instrument to be disposed thereon. The extension groove 21 communicates with the sliding groove 11. The extension groove 21 has a large dimension groove 211 and a small dimension groove 212, so that the extension groove 21 is stair-shaped. The small dimension groove 212 faces upward. The large dimension groove 211 faces downward. The large dimension groove 211 and the small dimension groove 212 communicate with each other. More particularly, the appearances of the large dimension groove 211 and the small dimension groove 212 are the same, but the sizes of the large dimension groove 211 and the small dimension groove 212 are different. The holder 20 has a flange 213 which is located between the large dimension groove 211 and the small dimension groove 212. As such, the optical instrument can be assembled on the holder 20 with a screw (not shown). The screw may pass through the small dimension groove 212 and screw on the optical instrument. The screw may also abut against the flange 213, so that the optical instrument can be firmly held on the holder 20. The extension groove 21 is located on the intermediate section 113 of the bottom surface 111. The fixation holes 12 are arranged along a longitudinal direction of the small dimension groove 212.

The sliding member 30 has a cross-section which is corresponding to a cross-section of the sliding groove 11. In other words, the sliding member 30 has a trapezoidal cross-section. The sliding member 30 is slidably disposed in the sliding groove 11. The sliding member 30 has a fixation surface 31 which faces downward. The sliding member 30 is formed with a threaded hole. The threaded hole is located on the fixation surface. The threaded hole is adapted for a tripod to be assembled thereon. At least one protruding piece is disposed on the sliding member 30. In the embodiment of the present invention, the protruding piece is a ball 32. The sliding member 30 has an exterior surface which faces the fixation holes 12. The exterior surface is formed with a hole 33. The hole 33 is adapted for the ball 32 to be disposed therein. A resilient member, such as spring, may be disposed between the ball 32 and the hole 33, so that the ball 32 protrudes outward from the hole 33. When the sliding member 30 moves to a predetermined position, the protruding piece (the ball 32) is selectively received in one of the fixation holes 12. As such, the sliding member 30 can be firmly disposed in the sliding groove 11. To make the fabrication of the sliding member 30 and the sliding groove 11 easier, two bottom edges 35 of the sliding member 30 are chamfered.

In addition, at least one stopping piece 14 may be disposed on the open end of the sliding groove 11, so that a route of the sliding member 30 is limited. More specifically, the sliding member 30 can move only in the sliding groove 11. In the embodiment of the present invention, the stopping piece 14 is a screw. The stopping piece 14 is disposed by the side of the small dimension groove 212. In other words, the stopping piece 14 is removably disposed on the open end.

In some cases, the size or the weight of the optical instrument may be extremely large. The positioning apparatus of the present invention can be enlarged as well. More specifically, the base seat 10 may be lengthened. Plurality of sliding member 30 can be disposed is the sliding groove 11. Each sliding member 30 is adapted for a tripod to be disposed thereon. Each sliding member 30 is formed with a fixation hole 36 which is located on the fixation surface 31, as shown in FIG. 2A. The fixation hole 36 is adapted for a pin of a tripod (not shown) to be received therein. As such, the sliding member 30 can not rotate with respect to the tripod.

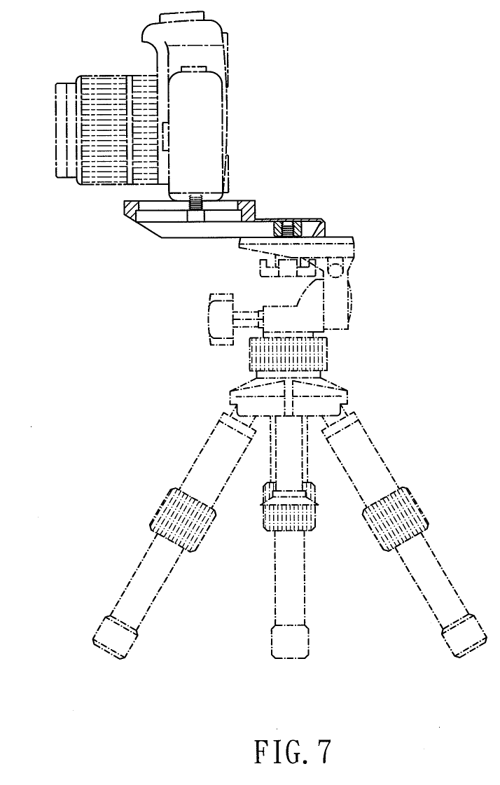

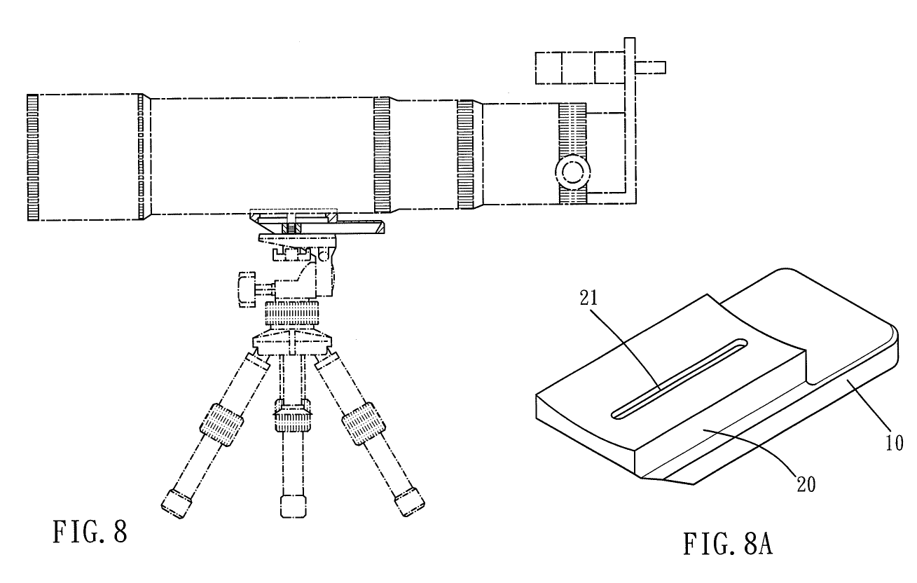

Accordingly, the positioning apparatus of the present invention connects an optical instrument to a tripod. The holder 20 is assembled on the optical instrument, and the sliding member 30 is assembled on the tripod. The sliding member 30 is slidably disposed with respect to the holder 20 in the sliding grove 11. The ball 32 is selectively received in one of the fixation holes 12, so that the sliding member 30 is movable with respect to the base seat 10 in multi-stage. The optical instrument may be a camera, as shown in FIG. 7, or a telescope, as shown in FIG. 8. An upper surface of the holder 20 may be a cambered surface for abutting against the telescope, as shown in FIG. 8A.

In the embodiment above of the present invention, the sliding groove has one open end. In other possible embodiments of the present invention, the sliding groove may have two open ends, or may have no open end. When the sliding groove has no open end, the sliding member may be disposed in the sliding groove by other possible methods.

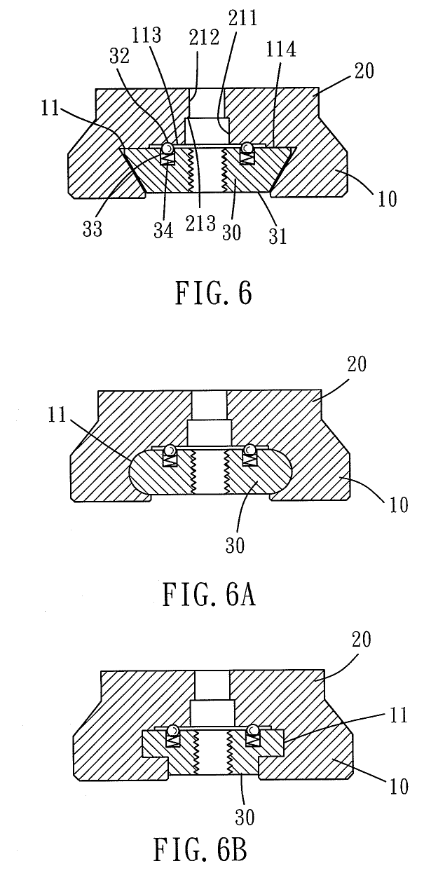

Please refer to FIG. 6A and FIG. 6B, in other possible embodiments of the present invention, the sliding groove may have a cross-section which is differ from the dovetail-shaped.

What is claimed is:

1. A positioning apparatus for an optical instrument, comprising:
a base seat, formed with a sliding groove at its bottom, the base seat having at least one wall surface, the sliding groove being defined by said wall surface, the sliding groove having an opening downward, a width of the opening being smaller than a maximum width of the sliding groove, said at least one wall surface being formed with plurality of fixation holes, the fixation holes being arranged along a longitudinal direction of the wall surface;
a holder, disposed on the base seat, the holder being adapted for the optical instrument to be assembled thereon;
at least one sliding member, a lateral cross-section of the sliding member corresponding to a cross-section of the sliding groove, so that the sliding member being slidably received in the sliding groove, the sliding member having a fixation surface downward, the sliding member being formed with a threaded hole, the threaded hole being located on the fixation surface, at least one protruding piece being disposed on the sliding member, the protruding piece being adapted for the fixation holes, so that the protruding piece being selectively received in one of the fixation holes.

2. The positioning apparatus of claim 1, wherein the holder is formed with an extension groove, the extension groove communicates with the sliding groove, the extension groove is stair-shaped, the extension groove has a large dimension groove and a small dimension groove, the small dimension groove faces upward, the large dimension groove faces downward, the large dimension groove and the small dimension groove communicate with each other.

3. The positioning apparatus of claim 1, wherein the sliding groove has a dovetail-shaped cross-section, the base seat has three wall surfaces, one of the wall surfaces is a bottom surface, the others of the wall surfaces are side surfaces.

4. The positioning apparatus of claim 3, wherein the fixation holes are located on the bottom surface, the fixation holes are arranged in two rows.

5. The positioning apparatus of claim 4, wherein the holder is formed with a extension groove, the extension groove communicates with the sliding groove, the extension groove is stair-shaped, the extension groove has a large dimension groove and a small dimension groove, the small dimension groove faces upward, the large dimension groove faces downward, the large dimension groove and the small dimension groove communicate with each other, the small dimension groove has a longitudinal direction, the fixation holes are arranged along the longitudinal direction of the small dimension groove.

6. The positioning apparatus of claim 3, wherein the bottom surface has an intermediate section and two side sections, the intermediate section connect one of the side sections to the other along a width direction of the bottom surface, a depth from the opening to the intermediate section is greater than a depth from the opening to each one of the side sections.

7. The positioning apparatus of claim 3, wherein the sliding groove has at least one open end in its longitudinal direction.

8. The positioning apparatus of claim 7, wherein the base seat is formed with a slant surface, the open end is located on the slant surface, the bottom surface is more protruding than the opening at the open end.

9. The positioning apparatus of claim 7, wherein the base seat is formed with a slant surface, the open end is located on the slant surface, the opening is more protruding than the bottom surface at the open end.

10. The positioning apparatus of claim 3, wherein the sliding member has a trapezoidal cross-section, two bottom edges of the sliding member are chamfered.

11. The positioning apparatus of claim 1, wherein the sliding groove has at least one open end in its longitudinal direction.

12. The positioning apparatus of claim 11, wherein at least one stopping piece is disposed on the open end, so that a route of the sliding member is limited.

13. The positioning apparatus of claim 12, wherein the stopping piece is a screw.

14. The positioning apparatus of claim 1, wherein the fixation surface is formed with a positioning hole.
